(19) United States
(12) Patent Application Publication
(10) Pub. No.: US 2018/0234592 A1
(43) Pub. Date: Aug. 16, 2018

(54) IMAGE FORMING APPARATUS AND METHOD OF ADJUSTING OUTPUT DENSITY OF IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Masashi Honda, Kannami Tagata (JP)

(21) Appl. No.: 15/460,436

(22) Filed: Mar. 16, 2017

(30) Foreign Application Priority Data
Feb. 15, 2017 (JP) 2017-026396

(51) Int. Cl. H04N 1/60; H04N 1/00

(52) U.S. Cl. CPC H04N 1/6027; H04N 2201/0094; H04N 1/00411; H04N 1/6019

(57) ABSTRACT

According to one embodiment, an image forming apparatus includes an image reading unit and a gradation correction table generation unit. The image reading unit reads an image. The gradation correction table generation unit, when the image reading unit reads a test image which includes a plurality of image areas formed based on the same density data in a main scan direction, generates a gradation correction table such that densities of output images in the main scan direction are close according to an area of the lowest density, which is read by the image reading unit, among the plurality of image areas in the same main scan direction.

### CROSS-REFERENCE TO RELATED APPLICATION

This application is based upon and claims the benefit of priority from Japanese Patent Application No. 2017-026396, filed Feb. 15, 2017, the entire contents of which are incorporated herein by reference.

### FIELD

Embodiments described herein relate generally to an image forming apparatus and a method of adjusting an output density of the image forming apparatus.

### BACKGROUND

In the related art, in an image forming apparatus of an electrophotography system, even though an image having an uniform density is printed, it is difficult to acquire an image having a uniform printing density because of light exposure, developing, and a variation in a mechanism dimension or an electrical characteristic of an image forming unit of a transfer process unit or the like. The variation in the mechanism dimension causes generation of a density gradient for a main scan direction from the front to the rear. In order to avoid the density gradient, high mechanism dimension accuracy is required, and it is very difficult to provide a countermeasure. Here, there is a method of making the density uniform by correcting the image while taking the density gradient into consideration. Specifically, there is a method of mainly using an analog light exposure amount correction system and supplementing with a digital look up table (LUT) system. Although it is possible to smoothly correct in-plane unevenness due to the density gradient by the analog light exposure amount correction system, fine adjustment is necessary in a digital LUT system, and thus there is a case where the process becomes complicated.

### DESCRIPTION OF THE DRAWINGS

FIG. 1 illustrates an external appearance view of an example of a whole configuration of an image forming apparatus according to one embodiment.

FIG. 2 illustrates a functional block diagram of a functional configuration of an in-plane unevenness correction process.

FIG. 3 illustrates a view of a detailed example of a test image in which gradation patch images are disposed in four areas .

FIG. 4 illustrates a view of a detailed example of an in-plane unevenness correction table.

FIG. 5 illustrates a view of a detailed example in which a graph of gradation characteristics for respective areas of the read test image is made.

FIG. 6 illustrates a view of a detailed example in which a graph of the in-plane unevenness correction table, acquired in a case where the gradation characteristics of FIG. 5 are acquired, is made.

FIG. 7 illustrates a view of a detailed example of the in-plane unevenness correction process performed by an in-plane unevenness correction processing unit.

FIG. 8 illustrates a view of a detailed example of a case where correction is performed in a boundary between an area 1 and an area 2 in the image forming apparatus.

FIG. 9 illustrates a view of a detailed example of a case where output is performed without performing the in-plane unevenness correction process on image information.

FIG. 10 illustrates a view of a detailed example of a case where output is performed based on the in-plane unevenness correction table.

FIG. 11 illustrates a view of a detailed example of a case where the in-plane unevenness correction process is performed according to another embodiment.

FIG. 12 illustrates a flowchart of a flow of an in-plane unevenness correction table preparation process.

FIG. 13 illustrates a flowchart of a flow of the in-plane unevenness correction process for a pixel of interest.

### DETAILED DESCRIPTION

An object of exemplary embodiments is to provide an image forming apparatus that is capable of further simply improving image quality deterioration due to print density unevenness, and a method of adjusting an output density of the image forming apparatus.

In general, according to one embodiment, an image forming apparatus includes an image reading unit and a gradation correction table generation unit. The image reading unit reads an image. The gradation correction table generation unit, when the image reading unit reads a test image which includes a plurality of image areas formed based on the same density data in a main scan direction, generates a gradation correction table such that densities of output images in the main scan direction are close according to an area of the lowest density, which is read by the image reading unit, among the plurality of image areas in the same main scan direction.

Hereinafter, an image forming apparatus and an image forming method according to embodiments will be described with reference to the accompanying drawings.

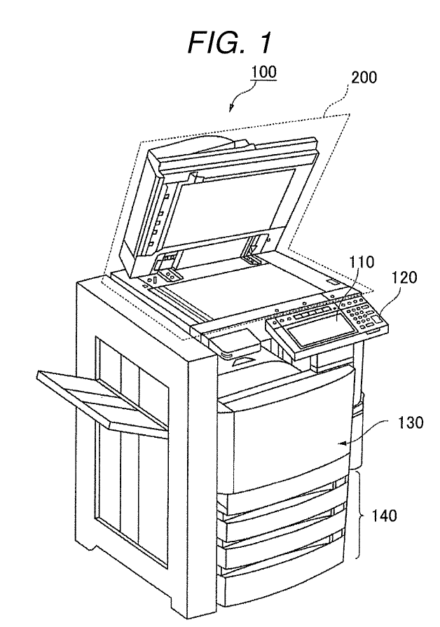

FIG. 1 illustrates an external appearance view of an example of a whole configuration of an image forming apparatus 100 according to one embodiment. The image forming apparatus 100 is, for example, a multi-function machine. The image forming apparatus 100 includes a display 110, a control panel 120, a printer unit 130, a sheet storage unit 140, and an image reading unit 200. Meanwhile, the printer unit 130 of the image forming apparatus 100 may be a device that fixes a toner image, and may be an ink jet-type device.

The image forming apparatus 100 forms an image on a sheet using a developer such as toner. A sheet is, for example, paper or label paper . The sheet may be a substance on which an image can be formed by the image forming apparatus 100 on a surface thereof.

The display 110 is an image display device such as a liquid crystal display and an organic electro luminescence (EL) display. The display 110 displays various pieces of information relevant to the image forming apparatus 100.

The control panel 120 includes a plurality of buttons. The control panel 120 receives an operation of a user. The control panel 120 outputs a signal according to the operation performed by the user to a control unit of the image forming apparatus 100. Meanwhile, the display 110 and the control panel 120 may be formed as an integral touch panel.

The printer unit 130 forms an image on a sheet based on image information generated by the image reading unit 200 or image information received through a communication path. The printer unit 130 forms an image by performing, for example, processes as below. An image forming unit of the printer unit 130 forms an electrostatic latent image on a photoconductive drum based on the image information. The image forming unit of the printer unit 130 forms a visible image by adhering the developer to the electrostatic latent image. Toner is a detailed example of the developer. A transfer unit of the printer unit 130 transfers the visible image onto the sheet. A fixing unit of the printer unit 130 fixes the visible image onto the sheet by performing heating and pressuring on the sheet. Meanwhile, the sheet on which the image is formed may be a sheet stored in the sheet storage unit 140 or may be a sheet which is manually fed.

The sheet storage unit 140 stores sheets used to form an image in the printer unit 130.

The image reading unit 200 reads image information of a reading target as brightness and darkness of light. The image reading unit 200 records the read image information. The recorded image information may be transmitted to another information processing apparatus through a network. The recorded image information may be formed as an image on a sheet by the printer unit 130.

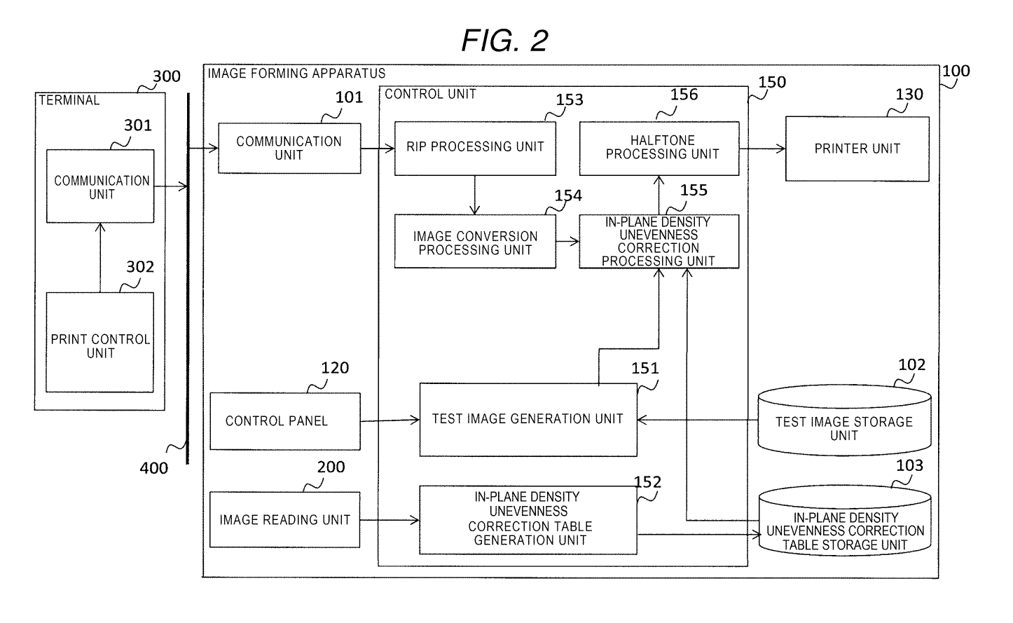

FIG. 2 illustrates a functional block diagram of a functional configuration in order to perform an in-plane unevenness correction process according to the embodiment. The image forming apparatus 100 and a terminal 300 are connected communicably to each other through a network 400. The network 400 may be constructed by any type of network. For example, the network 400 may be constructed by a local area network (LAN).

The image forming apparatus 100 includes a communication unit 101, a test image storage unit 102, an in-plane unevenness correction table storage unit 103, the control panel 120, the printer unit 130, a control unit 150, and the image reading unit 200.

The communication unit 101 is a network interface. The communication unit 101 communicates with the terminal 300 through the network 400. The communication unit 101 may perform communication using, for example, a communication system such as the local area network (LAN) and Bluetooth (registered trademark).

The test image storage unit 102 is formed using a storage device such as a magnetic hard disk device and a semiconductor storage device. The test image storage unit 102 stores test image data. The test image data is data used to form an image of a test image. The test image is an image in which gradation patch images corresponding to respective CMYK colors are disposed in a main scan direction. The test image includes one or more areas which are divided in a sub scan direction. The gradation patch images, which are disposed in the main scan direction in the test image, have the same density. The gradation patch images are respectively disposed for respective areas. The gradation patch images are images for adjusting the amount of developer to be adhered to a sheet. The test image data is stored in the test image storage unit 102 in advance.

The in-plane unevenness correction table storage unit 103 is formed using a storage device such as a magnetic hard disk device and a semiconductor storage device. The in-plane unevenness correction table storage unit 103 stores an in-plane unevenness correction table. The in-plane unevenness correction table is a table in which output values are stored in accordance with a gradation characteristic of an area of the lowest read value among a plurality of areas included in the test image . The output values are stored for the respective areas. The in-plane unevenness correction table is generated by an in-plane unevenness correction table generation unit 152. The in-plane unevenness correction table is generated for the respective CMYK colors. The in-plane unevenness correction table is an aspect of a gradation correction table.

The control unit 150 controls operations of the respective units of the image forming apparatus 100. The control unit 150 is executed by a device which includes, for example, a central processing unit (CPU) and a random access memory (RAM). The control unit 150 functions as a test image generation unit 151, the in-plane unevenness correction table generation unit 152, a raster image processor (RIP) processing unit 153, an image conversion processing unit 154, an in-plane unevenness correction processing unit 155, and a halftone processing unit 156 by executing an image forming program.

The test image generation unit 151 acquires the test image data stored in the test image storage unit 102. The test image generation unit 151 generates the test image based on the test image data. The test image generation unit 151 outputs the generated test image to the printer unit 130, and forms an image.

The in-plane unevenness correction table generation unit 152 generates the in-plane unevenness correction table based on the gradation characteristic of the test image read by the image reading unit 200. The in-plane unevenness correction table generation unit 152 generates the in-plane unevenness correction table to be close to a gradation characteristic of an area of the lowest solid density. The lowest solid density indicates the lowest read value (hereinafter, referred to as an “input value”) of the gradation characteristic. Thein-plane unevenness correction table generation unit 152 is capable of causing the density of the image data to be low. However, since it is difficult to cause the solid density decided by a process engine to be high, there is used a method of correcting an image in a gradation area, in which the solid density is high, using the image data based on the area of the lowest solid density. Other than the solid density, light and shade of the gradation of each area is adjusted by the image data.

The in-plane unevenness correction table generation unit 152 decides an output value of light exposure for the photoconductive drum based on the input value. An electric potential of the electrostatic latent image, which is formed on the photoconductive drum, is determined according to the output value of light exposure. The amount of toner adhered to the sheet is adjusted according to the electric potential. The solid density is determined according to the amount of toner adhered to the sheet. The in-plane unevenness correction table generation unit 152 is an aspect of a gradation correction table generation unit.

The RIP processing unit 153 converts a print job received from the terminal 300 in a raster type image data . The raster type is an image type in which color or density information is recorded in a pixel unit. The RIP processing unit 153 generates attribute information from the image data. The attribute information is the image information included in the image data which includes, for example, an image such as a photo, a graphic indicative of a figure such as a circle or a triangle, and text indicative of a character string. The RIP processing unit 153 outputs the image data and the attribute information to the image conversion processing unit 154. The print job is an image forming command which is given to the image forming apparatus 100. The print job includes image data which is formed as an image.

The image conversion processing unit 154 performs color conversion and a filter process on the image data received from the RIP processing unit 153. The color conversion is, for example, a process that improves reproduction of colors of the image data and gradations. The filter process includes, for example, a smoothing filter or a Gaussian filter. In a case of a known-method, any method may be used for the color conversion and the filter process. The image conversion processing unit 154 outputs the image data to the in-plane unevenness correction processing unit 155.

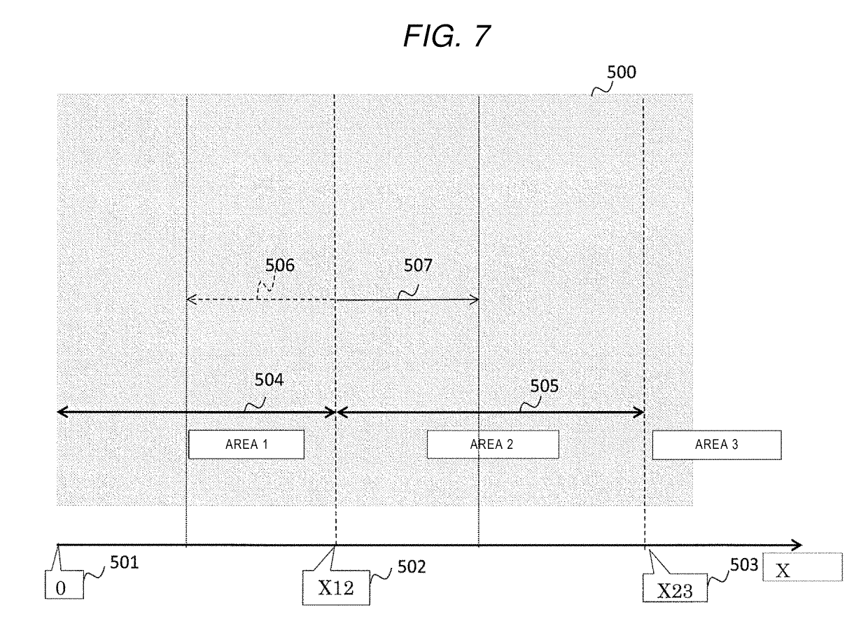

The in-plane unevenness correction processing unit 155 performs the in-plane unevenness correction process on each pixel of the image data based on the received image data and the in-plane unevenness correction table. In the in-plane unevenness correction process, the input value is corrected and the output value is decided based on the in-plane unevenness correction table and a prescribed method. The in-plane unevenness correction processing unit 155 decides an area of the in-plane unevenness correction table according to a coordinate value in the main scan direction. The prescribed method will be described with reference to FIG. 7 which will be described later.

The halftone processing unit 156 converts the image data, on which the in-plane unevenness correction is performed, into image data that is capable of being printed by the printer unit 130. The halftone processing unit 156 expresses multi-gradation by combining pixel values of a plurality of pixels which have prescribed gradations. The halftone processing unit 156 performs conversion on the image data using, for example, an error diffusion method, a dither method, or a density pattern method.

The terminal 300 is formed using an information processing apparatus such as a mainframe, a work station, or a personal computer. The terminal 300 includes a CPU, a memory, an auxiliary storage device, and the like which are connected through a bus. The terminal 300 functions as a device, which includes a communication unit 301 and a print control unit 302, by executing a print data generation program. Meanwhile, a whole or a part of respective functions of the terminal 300 may be realized using hardware such as ASIC, PLD, FPGA, or the like. The print data generation program may be recorded in a computer-readable recording medium. The computer-readable recording medium is, for example, a portable medium, such as a flexible disk, a magneto-optical disk, a ROM, a CD-ROM, and a semiconductor storage device (for example, SSD), and a storage device, such as a hard disk or a semiconductor storage device, which is embedded in a computer system.

The communication unit 301 is a network interface. The communication unit 301 communicates with the image forming apparatus 100. The communication unit 301 may perform communication using, for example, a communication system such as a LAN and Bluetooth. The print control unit 302 transmits a print job to the image forming apparatus 100 according to an operation of the user. The print control unit 302 is, for example, a printer driver.

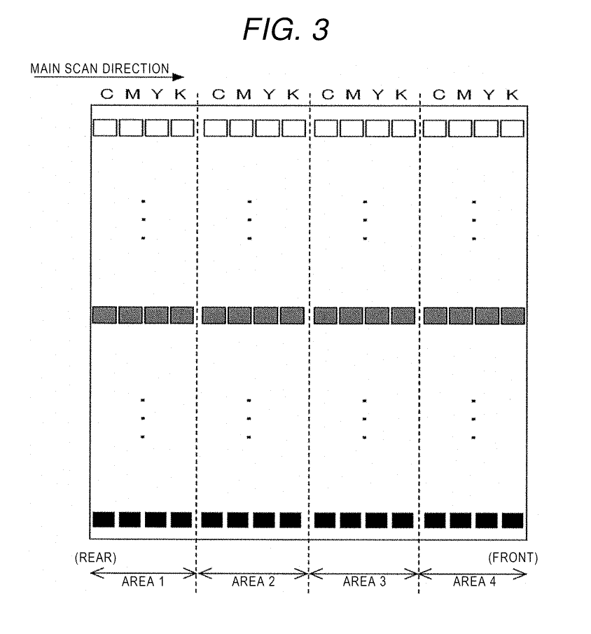

FIG. 3 illustrates a view of a detailed example of the test image in which the gradation patch images are disposed in four areas according to the embodiment. Images, which have gradations from density data 0 (zero) to density data 255, are formed in a sub scan direction. In the test image, a plurality of solid image parts, which are formed to correspond to the density data 255, are included. In a case of FIG. 3, four test image areas are formed along the main scan direction, and each of the test image areas is formed by four CMYK colors. The density data in the main scan direction is the same. The number of areas included in the test image is not limited to 4. For example, the number of areas may be five. Hereinafter, description will be performed while assuming that the number of areas is four.

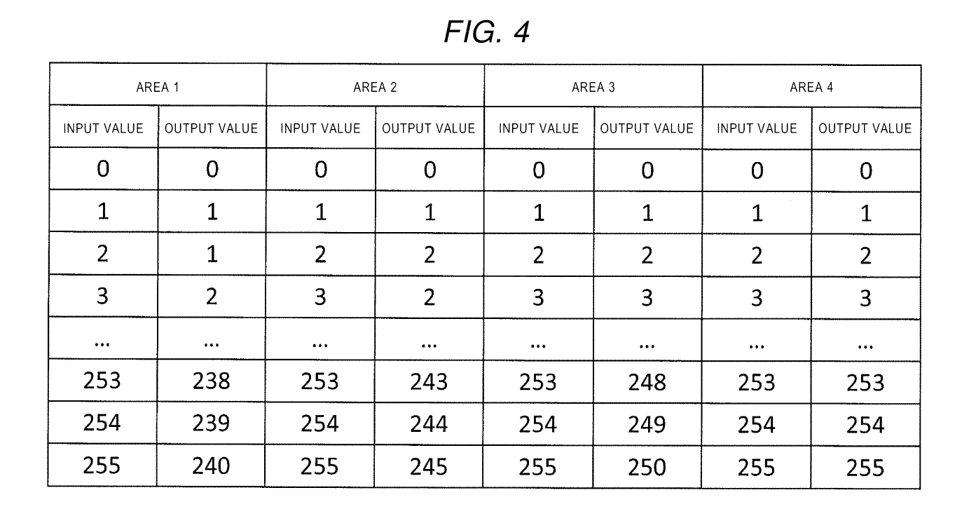

FIG. 4 illustrates a view of a detailed example of the in-plane unevenness correction table according to the embodiment. The in-plane unevenness correction table includes in-plane unevenness correction records. The in-plane unevenness correction records include values of an input value and an output value for each area. The area indicates an area included in the test image. The input value indicates a pixel value of input image data of the in-plane unevenness correction processing unit 155. The output value indicates an output value of the in-plane unevenness correction processing unit 155 in a case where the in-plane unevenness correction process is performed on the input value. The solid density indicates a density of a color in a state in which toner is adhered to a sheet. The in-plane unevenness correction table is generated for each of the CMYK colors.

In the example illustrated in FIG. 4, the uppermost records of the in-plane unevenness correction table are acquired in a case where an input value of an area 1 is “0”, an output value of the area 1 is “0”, an input value of an area 2 is “0”, an output value of the area 2 is “0”, an input value of an area 3 is “0”, an output value of the area 3 is “0”, an input value of an area 4 is “0” and the output value of the area 4 is “0”.Therefore, according to the uppermost records of the in-plane unevenness correction table, an image is formed such that all the output values are 0 in a case where all the input values of the read image data are 0. Meanwhile, the in-plane unevenness correction table illustrated in FIG. 4 is only the detailed example. Therefore, the in-plane unevenness correction table may be formed in an aspect which is different from that of FIG. 4. For example, in the in-plane unevenness correction table, all the CMYK colors may be expressed in one table.

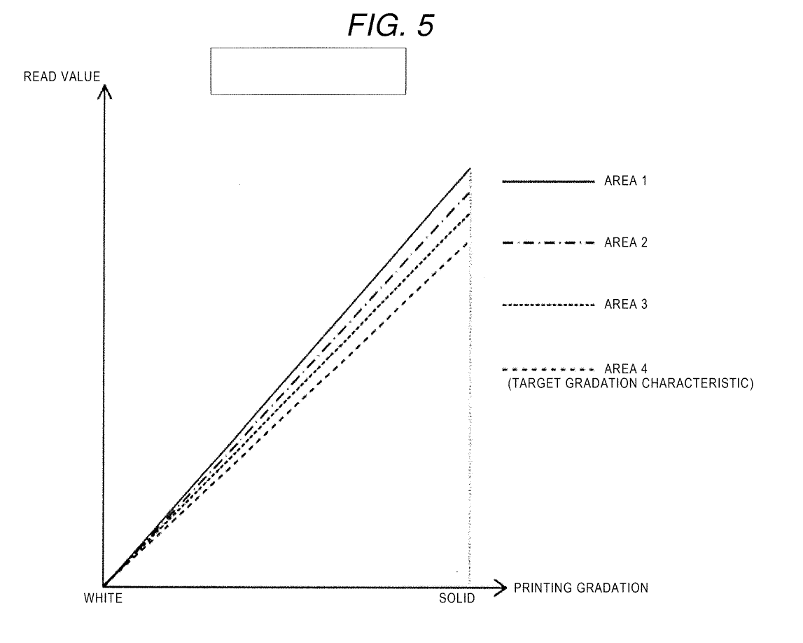

FIG. 5 illustrates a view of a detailed example in which a graph of gradation characteristics for the respective areas of the read test image is made according to the embodiment. A horizontal axis indicates a data gradation value of the test image. A solid expresses 255 in 8-bit image data. A vertical axis indicates a read value which is read for a printing gradation of the test image. The in-plane unevenness correction table generation unit 152 calculates the in-plane unevenness correction table based on the read values. The in-plane unevenness correction table generation unit 152 sets a gradation characteristic of an area of the lowest read value of the solid as a target gradation characteristic. In a case of FIG. 5, the in-plane unevenness correction table generation unit 152 sets the area 4 to the target gradation characteristic. The target gradation characteristic is a target value of the output values of other areas. The output values are generated to be close to the target gradation characteristic in a case where the in-plane unevenness correction table is generated.

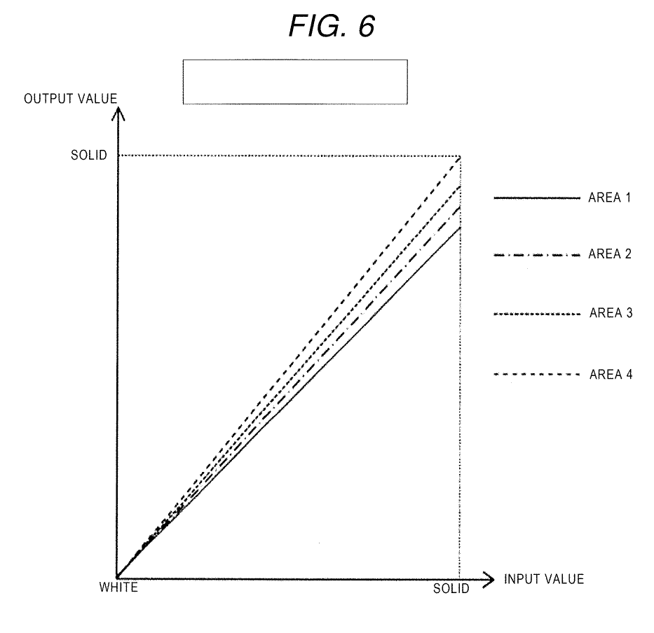

FIG. 6 illustrates a view of a detailed example in which a graph of the in-plane unevenness correction table, acquired in a case where the gradation characteristics of FIG. 5 are acquired, is made according to the embodiment. In the area 4 of the lowest read value of the solid, the input value and the output value are the same. Therefore, the area 4 is expressed linearly. The other areas are expressed in curved shapes such that the output values for the input values are close to the area 4. Therefore, all the areas are close to the area 4, and thus density unevenness is eliminated in a case where an image is formed.

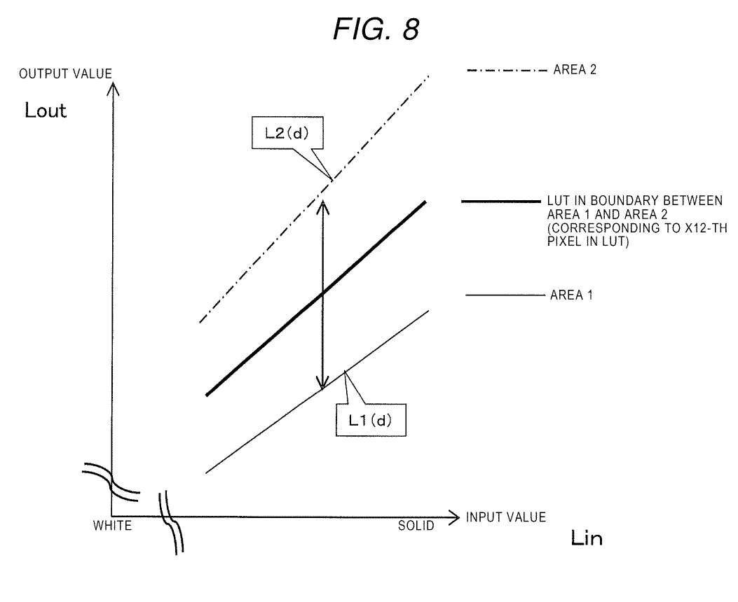

FIGS. 7 and 8 illustrate views of detailed examples of the in-plane unevenness correction process performed by the in-plane unevenness correction processing unit 155 according to the embodiment. An area 500 indicates a part of the image data on which the in-plane unevenness correction process is performed. A tooltip 501 indicates an origin of coordinates of the image information. A value of the origin of the coordinates is 0. A tooltip 502 indicates a coordinate point which is a boundary between the area 1 and the area 2. A value of the coordinate point which is the boundary between the area 1 and the area 2 is set to X12. A tooltip 503 indicates a coordinate point which is a boundary between the area 2 and the area 3. A value of the coordinate point which is the boundary between the area 2 and the area 3 is set to X23. An arrow 504 indicates coordinate points which include the area 1. Values of the coordinate points of the area 1 are equal to or larger than 0 and are less than X12. An arrow 505 indicates coordinate points which include the area 2. Values of the coordinate points which include the area 2 are equal to or larger than X12 and are smaller than X23. An arrow 506 indicates coordinate points of the area 1, which are included in the number of prescribed pixels from X12. An arrow 507 indicates coordinate points of the area 2, which are included in the number of prescribed pixels from X12. In FIG. 7, the number of prescribed pixels is 255. The number of prescribed pixels is not limited to 255 and may be any value.

A prescribed method performed by the in-plane unevenness correction processing unit 155 will be described. A coordinate value of a pixel which is a target of the in-plane unevenness correction process (hereinafter, referred to as “pixel of interest”) is set to X. A density value acquired before correction is performed on the pixel of interest is set to d. A correction density value of the area 1 of the in-plane unevenness correction table for the density value d acquired before correction is performed is set to L1 (d). A correction density value of the area 2 of the in-plane unevenness correction table for the density value d acquired before correction is set to L2 (d). The in-plane unevenness correction processing unit 155 decides an output value Lout by performing calculation based on the values and the number of prescribed pixels.

Specifically, the in-plane unevenness correction processing unit 155 decides the output values Lout of the area 1 and the area 2 based on calculation formulas below. In a case where the coordinate value X is in a state in which X<(X12−255), Lout=L1 (d). Ina case where the coordinate value X is in a state in which (X12+255)<X, Lout=L2(d). In a case where the coordinate value X is in a state in which (X12−255)≤X≤(X+255), Lout is acquired according to Equation (1).

As a result, from the boundary to 255 pixels up to the area 1 or the area 2, the in-plane unevenness correction processing unit 155 performs the in-plane unevenness correction process based on Equation (1) according to a pixel position from the boundary.

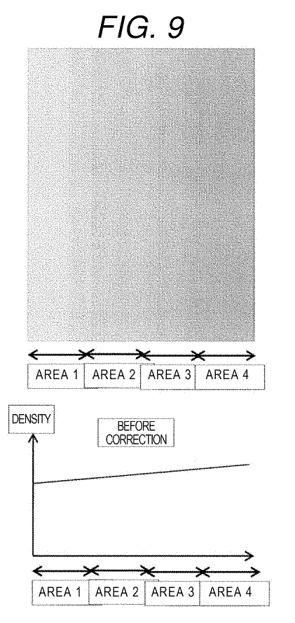

FIG. 9 illustrates a view of a detailed example of a case where output is performed without performing the in-plane unevenness correction process on the image information. FIG. 9 illustrates an image in which entirely uniform density data is printed. In FIG. 9, since the image is not corrected, the same uniform density is not acquired, and thus the image is formed in an uneven state.

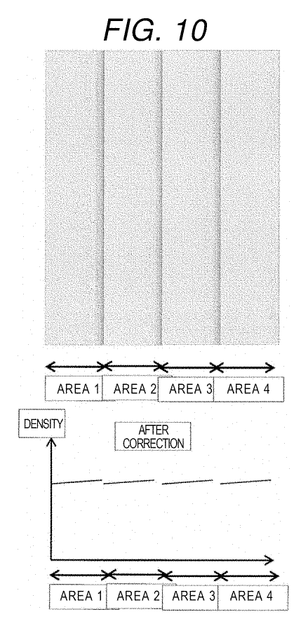

A process example illustrated in FIG. 10 is an example of a case where boundaries between the areas of the in-plane unevenness correction table are not processed. In a case where the in-plane unevenness correction table is only applied, output values are different in boundary parts even through input values are the same. Therefore, in a case where correction is performed in the in-plane unevenness correction table, differences in densities appear in the boundaries between the areas, and thus smooth output values are not acquired unlike an analog light exposure amount correction system.

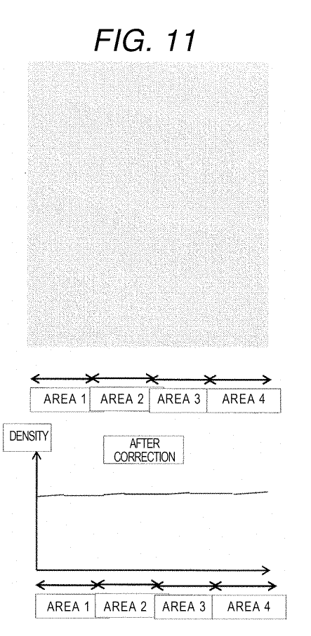

FIG. 11 illustrates a view of a detailed example of a case where the in-plane unevenness correction process is performed according to the embodiment. In FIG. 11, the boundaries between the areas are corrected based on an in-plane unevenness correction table of an area which includes the pixel of interest and in-plane unevenness correction tables of areas which are close to the pixel of interest. Therefore, it is possible to smoothly correct in-plane unevenness with a digital in-plane unevenness correction process as in the embodiment.

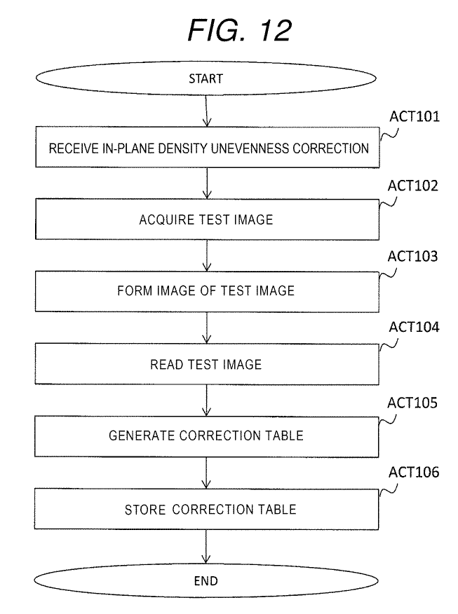

FIG. 12 illustrates a flowchart of a flow of an in-plane unevenness correction table preparation process according to another embodiment. The control panel 120 receives an instruction of the in-plane unevenness correction process from the user (ACT101). The test image generation unit 151 acquires a test image from the test image storage unit 102 (ACT102). The test image generation unit 151 outputs the test image to the printer unit 130. The printer unit 130 forms an image of the test image (ACT103).

The image reading unit 200 reads the test image (ACT104). The in-plane unevenness correction table generation unit 152 generates an in-plane unevenness correction table based on image data of the read test image (ACT105). The in-plane unevenness correction table generation unit 152 stores the in-plane unevenness correction table in the in-plane unevenness correction table storage unit 103 (ACT106).

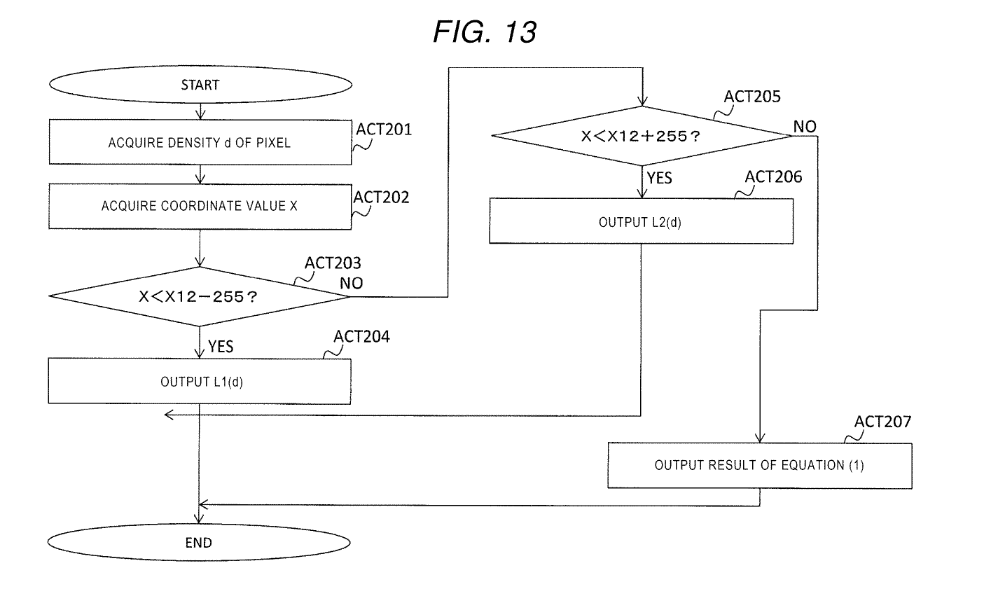

FIG. 13 illustrates a flowchart of a flow of the in-plane unevenness correction process for the pixel of interest according to the embodiment. FIG. 13 illustrates pixels of the area 1 and the area 2 as examples. In FIG. 13, the number of prescribed pixels is 255. The in-plane unevenness correction processing unit 155 acquires a density value d of the pixel of interest (ACT201). The in-plane unevenness correction processing unit 155 acquires a coordinate value X of the pixel of interest (ACT202). The in-plane unevenness correction processing unit 155 determines whether or not X is smaller than (X12−255) (ACT203). In a case where X is smaller than (X12−255) (ACT203: YES), the in-plane unevenness correction processing unit 155 outputs L1(d) as the output value (ACT204).

In a case where X is not smaller than (X12−255) (ACT203: NO), the in-plane unevenness correction processing unit 155 determines whether or not X is smaller than (X12+255) (ACT205). In a case where the X is smaller than (X12+255) (ACT205: YES), the in-plane unevenness correction processing unit 155 outputs L2(d) as the output value (ACT206). In a case where X is not smaller than (X12+255) (ACT205: NO), the in-plane unevenness correction processing unit 155 outputs a result of Equation (1) as the output value (ACT207).

With the above-described configuration, the in-plane unevenness correction processing unit 155 performs the in-plane unevenness correction process in the boundaries of the areas based on the in-plane unevenness correction table of the area which includes the pixel of interest and the in-plane unevenness correction tables of the areas which are close to the pixel of interest. Accordingly, it is possible for the in-plane unevenness correction processing unit 155 to prevent a phenomenon in which differences in densities appear in the respective areas. Therefore, print density unevenness is eliminated through the in-plane unevenness correction process, and thus it is possible to improve image quality deterioration. Meanwhile, in the above-described embodiments, from a view of reduction in memory capacity, the test image, in which the gradation patch images are disposed in four areas, is formed. The reason for this is to enable density data of the four areas to be respectively stored in separate memories. However, it is not essentially necessary to divide the test image into a plurality of areas, and the image density may be adjusted according to an area of the lowest density in an image which is formed based on the same density data.

According to at least one above-described embodiment, in a case where the in-plane unevenness correction processing unit 155 is included, it is possible to further simply improve image quality deterioration due to print density unevenness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
a processor the executes instructions that facilitate performance of operations, comprising:
reading an image;
in response to reading a test image which includes a plurality of image areas formed based on a same density data in a main scan direction, generating a gradation correction table such that maximum densities in the main scan direction of output images to be formed by the image forming apparatus are close to an area of a lowest density among a plurality of image areas read in the main scan direction; and
adjusting an electrostatic potential of an electrostatic latent image formed on a photoconductive drum associated with the image forming apparatus based on the lowest density.

2. The apparatus according to claim 1,
wherein the test image includes a solid image part which is formed based on the same density data in the main scan direction, and
wherein the operations further comprise generating the gradation correction table such that the densities of the output images in the main scan direction are close according to the area of the lowest density among a plurality of solid image areas read in the main scan direction.

3. The apparatus according to claim 1, wherein the operations further comprise:
performing correction using a prescribed calculation formula such that a difference between correction tables corresponding to respective image areas is small for a first gradation correction table and a second gradation correction table generated based on results acquired by reading the plurality of image areas.

4. The apparatus according to claim 3,
wherein the prescribed calculation formula of a case where a coordinate value of a pixel of interest of the image is included in a number of prescribed pixels from a boundary between the respective image areas is different from that of a case where the coordinate value of the pixel of interest of the image is not included in the number of prescribed pixels from the boundary between the respective image areas.

5. A method of adjusting an output density of the image forming apparatus, comprising:
reading, by a device comprising a processor, a test image, which includes a plurality of image areas formed based on a same density data in a main scan direction;
generating, by the device, a gradation correction table such that maximum in the main scan direction densities of output images formed by the device are close to an area of a lowest density among a plurality of image areas read in the main scan direction; and
adjusting an electrostatic potential of an electrostatic latent image formed on a photoconductive drum associated with the image forming apparatus based on the lowest density.
